(19) United States
(12) Patent Application Publication
(10) Pub. No.: US 2007/0050068 A1
(43) Pub. Date: Mar. 1, 2007

(54) Optimization method for optimizing shape of component

(75) Inventor: Makoto Sakairi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/288,144

(22) Filed: Nov. 29, 2005

(30) Foreign Application Priority Data
Aug. 30, 2005 (JP) 2005-248552

(51) Int. Cl. G06F 19/00

(52) U.S. Cl. 700/98

(57) ABSTRACT

An optimization method for optimizing a shape of a component includes the steps of setting information including a shape of each part in the component to plural parameters, extracting a relationship between the plural parameters and a deformation of the component, changing a value of at least one of the plural parameters so as to reduce a deformation of the component, and adjusting a volume of the component.

This application claims the right of a foreign priority based on Japanese Patent Application No. 2005-248552, each filed on Aug. 30, 2005, which is hereby incorporated by reference herein in its entirety as if fully set forth herein.

### BACKGROUND OF THE INVENTION

The present invention relates generally to a method for optimizing a shape of a component. The present invention is suitable, for example, for a method for optimizing a shape of a head gimbal assembly (“HGA”) that supports and drives a head in a hard disc drive (“HDD”).

Conventionally, a method for optimizing a component's shape has been proposed. One illustrative component is, for example, a HGA used for the HDD. The HDD typically includes a disc on which a magnetic material is adhered, and a HGA that supports a head and moves the head to a target position on the disc. The HGA includes a carriage (also referred to as an “actuator”, an “E-block” due to its E-shaped section or “actuator (“AC”) block”), a suspension attached to a support portion of the carriage (referred to as an “arm” hereinafter), a magnetic head part supported on the suspension, and a base plate that attaches the suspension to the arm. The magnetic head part includes a fine head core (simply referred to as a “head” hereinafter) that records and reproduces a signal, and a slider that supports the head.

The suspension also serves as a flat spring that compresses the slider against the disc at a predetermined compression force. As the disc rotates, the airflow or air bearing occurs between the slider and the disc, and floats the slider from the disc surface. The floating slider is spaced from the disc by a predetermined distance due to a balance between the floating force and the compression force. In this state, the arm rotates and moves the head to (seek for) a target position on the disc, for information reading and writing.

A recent high-density disc requires high head positioning precision, and thus the HGA should be manufactured precisely. For example, when the suspension warps or twists due to the manufacturing errors, the compression force, the flying height, the orientation and vibration tolerance may vary from the designated values, and the positioning accuracy deteriorates.

In the HGA, the suspension and base plate are laser-welded to each other, whereas the base plate is swaged or caulked with the arm. The swaging is the way of jointing the base plate with the arm by crushes or plastically deforms part of the base plate against the arm. The swaged base plate and arm are separable when a sharp member is inserted between them, and improves the economical efficiency of the magnetic disc drive, because when the suspension and the magnetic head part are defective, it is sufficient to replace only the base plate side instead of the entire HGA.

The HGA manufacturing method first forms a dent (often referred to as a “boss”) having a perforation hole in a flat base plate through press work, and forms a perforation hole in the arm. Next, the method inserts the boss into the arm's perforation hole, and passes a swaging ball through the boss's perforation hole so as to plastically deform the boss (swaging or caulking).

However, the force for the plastic deformation of the base plate causes a deformation of the base plate, such as a warp, and deteriorates the head positioning accuracy. In order to reduce the deformation, the optimization of the boss's shape is effective.

It has been already known to optimize a boss's shape by actually making a prototype or through simulation. However, it is costly and time-consuming to make the prototype because making it needs some types of jigs, the optimization through simulation is preferable using the boss shape as a parameter. Such a simulator is commercially available, for example, as iSIGHT manufactured by Engineous Japan, Inc. Prior art includes, for example, Japanese Patent No. 3,394,086.

However, the conventional optimization cannot efficiently optimize the component's shape: For example, the conventional HGA simulator does not weigh or has difficulties in weighing an interrelation of parameters of the boss's shape, resulting in an insufficient or excessively time-consuming optimization of the boss's shape. Since the boss is formed through the press work to a plate part of the base plate, the boss's worked volume or mass cannot exceed the original plate part. Suppose that the simulation result suggests to make thick and long a certain part of the boss. If the certain part is made thick and long without changing other parts' shapes, the simulated boss's volume increases and exceeds the original volume of the plate part. Therefore, the shape cannot be corrected due to the volume limitations. In addition, when another part is made thin and short to maintain the boss's volume, the boss's shape may be no longer optimal.

### BRIEF SUMMARY OF THE INVENTION

Accordingly, it is an illustrative object of the present invention to provide an optimization method that effectively optimizing a component's shape.

An optimization method according to one aspect of the present invention for optimizing a shape of a component includes the steps of setting information including a shape of each part in the component to plural parameters, extracting a relationship between the plural parameters and a deformation of the component, changing a value of at least one of the plural parameters so as to reduce a deformation of the component, and adjusting a volume of the component. This optimization method has the volume adjusting step and can solve a problem in that the volume or mass of the component runs short. The extracting step preferably uses a design of experiments that uses an orthogonal array, thereby reducing the number of experiments for extraction for fast processing.

An optimization method according to another aspect of the present invention for optimizing a shape of a component includes the steps of setting information including a shape of each part in the component to plural parameters, extracting first and second parameters from among the plural parameters, the first parameter whose influence to a deformation of the component is greater than a predetermined threshold, and the second parameter whose influence to the deformation of the component is smaller than a predetermined threshold, optimizing the component by changing a value of the first parameter so as to reduce a deformation of the component, and adjusting a volume of the component by changing a value of the second parameter. This optimization method has the volume adjusting step and can solve a problem in that the volume or mass of the component runs short. The extracting step may extract the first parameter by changing the plural parameters within a predetermined range irrespective of the volume of the component. This method does not weigh the volume, and can expedite the method or simulation.

The extracting step may extract plural first parameters and rank the plural first parameters in the most influential order to the deformation of the component, wherein the optimizing step uses the plural first parameters in ascending order of ranking. This configuration can maximize the component's deformation reducing effect (or optimization). The extracting step may extract plural second parameters and rank the plural second parameters in the least influential order to the deformation of the component, wherein the optimizing step uses the plural second parameters in ascending order of ranking. This configuration can minimize the influence of the deformation of the component de to the volume adjustment. The extracting step may extract plural first parameters and rank the plural first parameters in the most influential order to the deformation of the component, wherein the optimizing step uses the plural first parameters in ascending order of ranking, and wherein the adjusting step uses the plural first parameters in descending order of the ranking. This method is effective when only the second parameters cannot adjust the volume of the component.

An optimization method according to still another aspect of the present invention for optimizing a shape of a component includes the steps of setting information including a shape of each part in the component to plural parameters, extracting plural first parameters from among the plural parameters, each first parameter having influence to a deformation of the component greater than a predetermined threshold, extracting first and second sub-parameters from among the plural first parameters, the first sub-parameter increasing a volume of the component when the first sub-parameter is changed so as to reduce the deformation of the component, and the second sub-parameter decreasing the volume of the component when the second sub-parameter is changed so as to reduce the deformation of the component, optimizing the component and adjusting the volume of the component by utilizing the first and second sub-parameters. Use of only the first parameters enhances the component's deformation reducing effect.

The information may further include information that is irrelevant to the shape of the component.

Other objects and further features of the present invention will become readily apparent from the following description of the preferred embodiments with reference to accompanying drawings.

### BRIEF DESCRIPTION OF THE DRAWINGS

FIG. 1 is an internal structure of a hard disc drive (“HDD”) according to one embodiment of the present invention.

FIG. 2 is an enlarged perspective view of a magnetic head part in the HDD shown in FIG. 1.

FIGS. 3A to 3C are left side, plane and right side views, respectively, showing a detailed structure of a head stack assembly (“HGA”) shown in FIG. 1.

FIGS. 4A and 4B are schematic plane and sectional views of a suspension jointed with a base plate.

FIGS. 5A and 5B are schematic plane and sectional views of the base plate shown in FIGS. 4A and 4B.

FIG. 6 is a flowchart for explaining a manufacturing method of the base plate shown in FIGS. 5A and 5B.

FIG. 7 shows schematic plane and sectional views of a boss in the base plate shown in FIGS. 5A and 5B.

FIG. 8 is a boss shape optimization flow in a base-plate forming step in FIG. 6.

FIG. 9A is a partial sectional and perspective view of caulking shown in FIG. 6, and FIG. 9B is a partial sectional view of a T part shown in FIG. 9A.

FIG. 10 is a flowchart showing detailed steps 1200 and 1300 shown in FIG. 8.

FIG. 11 is a schematic enlarged sectional view of a setting example of the parameters for optimization of the shape of the base plate shown in FIG. 9B.

FIG. 12 is a graph showing one example of a factor analysis result of the parameters shown in FIG. 10.

FIG. 13 is a schematic sectional view for explaining caulking between the base plate and arm shown in FIGS. 5A and 5B.

FIG. 14 is a block diagram of a control system in the HDD shown in FIG. 1.

FIGS. 15A to 15C are schematic sectional views showing an adjustment of a volume of the boss part.

### DETAILED DESCRIPTION OF THE PREFERRED EMBODIMENTS

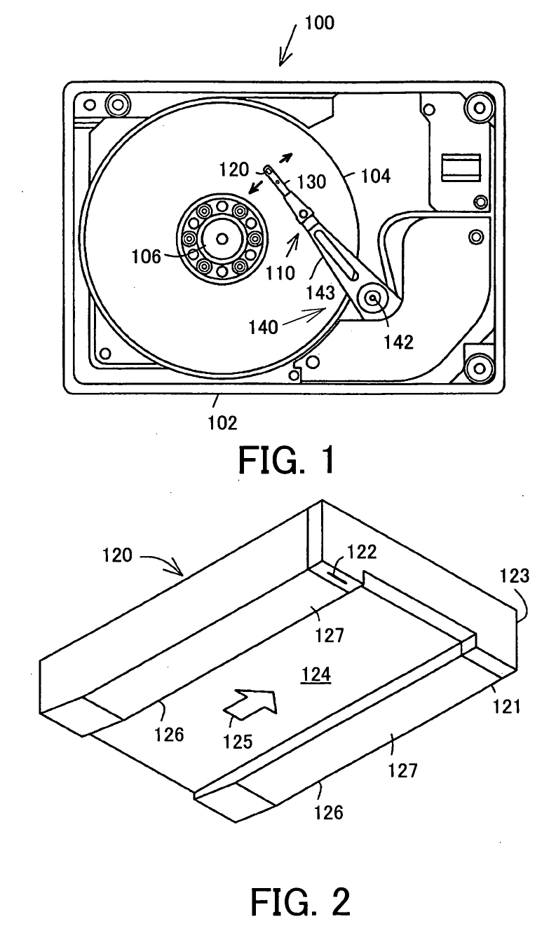

Referring now to the accompanying drawings, a description will be given of a HDD 100 according to one embodiment of the present invention. The HDD 100 includes, as shown in FIG. 1, plural magnetic discs 104 each serving as a recording medium, a spindle motor 106, and a HGA 110 in a housing 102. Here, FIG. 1 is a schematic plane view of the internal structure of the HDD 100.

The housing is made, for example, of aluminum die cast base and stainless steel, and has a rectangular parallelepiped shape to which a cover (not shown) that seals the internal space is jointed. The magnetic disc 104 of this embodiment has a high surface recording density, such as 100 Gb/in² or greater. The magnetic disc 104 is mounted on a spindle of the spindle motor 106 through its center hole of the magnetic disc 104.

The spindle motor 106 rotates the magnetic disc 104 at such a high speed as 15,000 rpm, and has, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle. Unlike this embodiment, the magnetic disc 104 may be a disc that has no center hole but a hub, and the spindle rotates the disc via the hub.

The HGA 100 includes a magnetic head part 120, a suspension 130, a carriage 140, and a base plate 150.

The magnetic head 120 includes, as shown in FIG. 2, an approximately square, Al₂O₃—TiC (Altic) slider 121, and a head device built-in film 123 that is jointed with an air outflow end of the slider 121 and has a reading and recording head 122. Here, FIG. 2 is an enlarged view of the magnetic head part 120. The slider 121 and the head device built-in film 123 define a medium opposing surface to the magnetic disc 104, i.e., a floating surface 124. The floating surface 124 receives airflow 125 that occurs with rotations of the magnetic disc 104.

A pair of rails 126 extend on the floating surface 124 from the air inflow end to the air outflow end. A top surface of each rail 126 defines a so-called air-bearing surface (“ABS”) 127. The ABS 127 generates the buoyancy due to actions of the airflow 125. The head 122 embedded into the head device built-in film 123 exposes from the ABS 127. The floating system of the magnetic head part 120 is not limited to this mode, and may use known dynamic and static pressure lubricating systems, piezoelectric control system, and other floating systems. The activation system may be a contact start stop (“CSS”) system in which the magnetic head part 120 contacts the disc 104 at the stop time, or a dynamic or ramp loading system in which the magnetic head part 120 is lifted up from the disc 104 at the stop time and held on the ramp outside the disc 104 while the magnetic head part 120 does not contact the disc 104, and the magnetic head part 120 is dropped from the holding part to the disc 104 at the start time.

The head 122 is a MR inductive composite head that includes an inductive head device that writes binary information in the magnetic disc 104 utilizing the magnetic field generated by a conductive coil pattern (not shown), and a magnetoresistive (“MR”) head that reads the binary information based on the resistance that varies in accordance with the magnetic field applied by the magnetic disc 104. A type of the MR head device is not limited, and may use a giant magnetoresistive (“GMR”), a CIP-GMR (“GMR”) that utilizes a current in plane (“CIP”), a CPP-GMR that utilizes a perpendicular to plane (“CPP”), a tunneling magnetoresistive (“TMR”), an anisotropic magnetoresistive (“AMR”), etc.

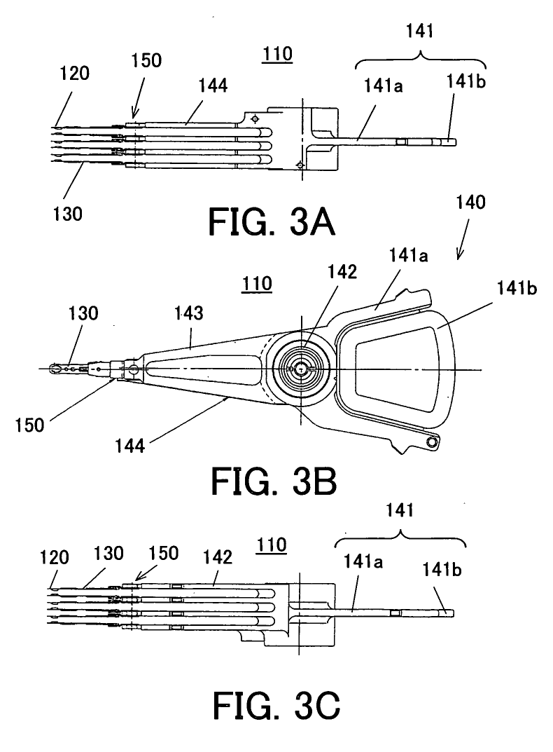

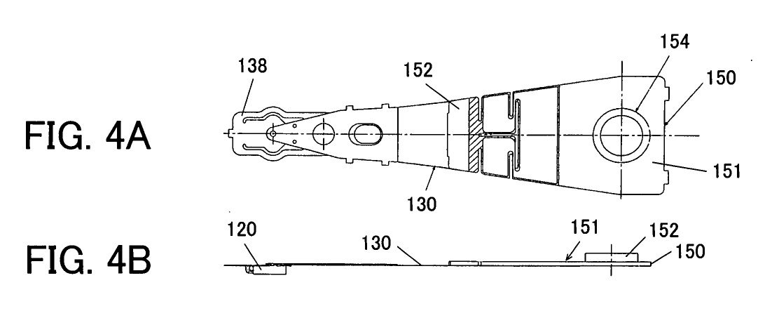

The suspension 130 serves to support the magnetic head part 120 and to apply an elastic force to the magnetic head part 120 against the magnetic disc 104, and is, for example, a Watlas type suspension made of stainless steel. This type of suspension has a flexure (also referred to as a gimbal spring or another name) which cantilevers the magnetic head part 120, and a load beam (also referred to as a load arm or another name) which is connected to the base plate. The load beam has a spring part at its center so as to apply a sufficient compression force in a Z direction. Therefore, the load beam includes a rigid part at its proximal end, a spring part at its center, and a rigid part at its distal end. The load beam contacts the flexure via a projection called a dimple (referred to as a pivot or another name) so that the ABS 124 follows the disc's warp and swell and it is always parallel to the disc surface. The magnetic head part 120 is designed to softly pitch and roll around the dimple. The suspension 130 also supports a wiring part 138 that is connected to the magnetic head part 120 via a lead etc. The wiring part 138 is shown in FIG. 4A, which will be described later. Via this lead, the sense current flows and read/write information is transmitted between the head 122 and the wiring part 138. The wiring part 138 is connected to a relay flexible circuit board (“FPC”) 143 under the arm 144 shown in FIG. 3B.

As described later, this embodiment reduces the warp amount of the base plate 150 and thus improves the flatnesses of the suspension 130 and the magnetic head part 120, thereby preventing crushes and maintaining positioning accuracy due to excessive elastic force and torsion force.

The carriage 140 serves to rotate the magnetic head part 120 in arrow directions shown in FIG. 1 and includes, as shown in FIGS. 1 and 3A to 3C, a voice coil motor 141, a support shaft 142, a FPC 143, and an arm 144. Here, FIG. 3A is a left side view of the HGA 110. FIG. 3B is a plane view of the HGA 110. FIG. 3C is a right side view of the HGA 110. While FIGS. 3A to 3C show the carriage 140 that drives six magnetic head parts 120 that record and reproduce both sides of three discs 104, the number of discs is, of course, not limited to three.

The voice coil motor 141 has a flat coil 141b between a pair of yokes 141a. The flat coil 141b opposes to a magnetic circuit (not shown) provided to the housing 102 of the HDD 100, and the carriage 140 swings around the support shaft 142 in accordance with values of the current that flows through the flat coil 141b. The magnetic circuit includes, for example, a permanent magnet fixed onto an iron plate fixed in the housing 102, and a movable magnet fixed onto the carriage 140. The support shaft 142 is inserted into a hollow cylinder in the carriage 140, and extends perpendicular to the paper surface of FIG. 1 in the housing 102. The FPC 143 provides the wiring part 138 with a control signal, a signal to be recorded in the disc 104, and the power, and receives a signal reproduced from the disc 104.

The arm 144 is an aluminum rigid body that can rotate or swing around the support axis 142, and has a perforation hole 145 at its top, which will be described later. The suspension 130 is attached to the arm 144 via the perforation hole 145 in the arm 144 and the base plate 150. The arm 144 has a comb shape when viewed from a side as shown in FIGS. 3A and 3C.

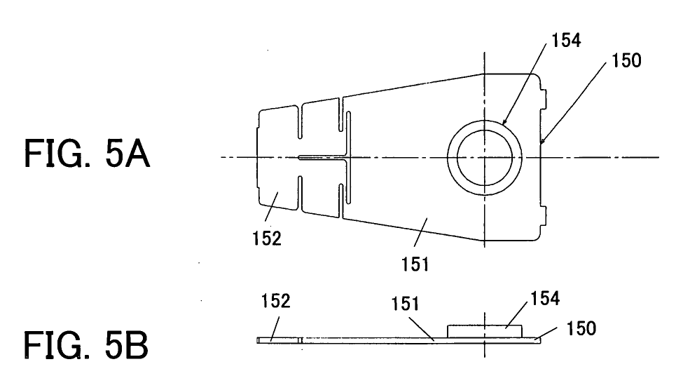

The base plate 150 serves to attach the suspension 130 to the arm 144, and includes, as shown in FIGS. 4A to 5B, a plate section 151, a welded section 152, and a dent or dowel 154. The welded portion 152 is a tip of the plate section 151 to be laser-welded with the suspension 130. The boss 154 is a part to be swaged with the arm 144. Here, FIG. 4A is a schematic plane view of the suspension 130 jointed with the base plate 150. FIG. 4B is a schematic sectional view of that suspension 130. FIG. 5A is a schematic plane view of the base plate 150. FIG. 5B is a schematic sectional view of the base plate 150.

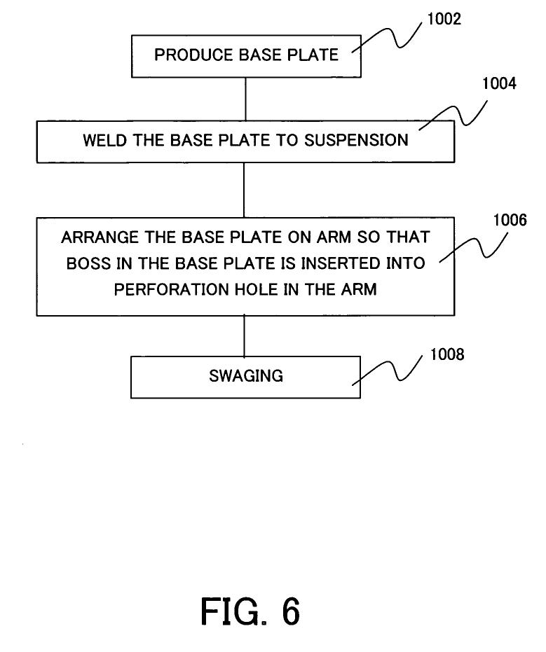

A description will now be given of a connection between the arm 144 and the base plate 150. The second and third arms 144 from the top in FIG. 3A have a double-head structure, in which the base plates 150 are attached to both sides of the arm 144. The first and fourth arms 144 from the top in FIG. 3A have a single-head structure, in which the base plates 150 are attached to a single side of the arm 144. The present invention is applicable to both the double-head structure and the single-head structure. In this embodiment, a description will be given of the connections between the second arm 144 from the top in FIG. 3A a pair of base plates 150. Here, FIG. 6 is a flowchart for explaining connections between the arm 144 and the base plates 150.

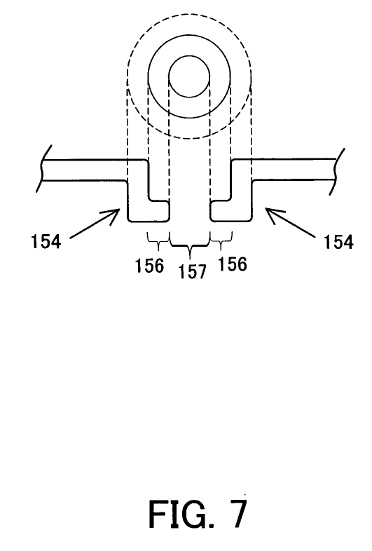

First, as shown in FIGS. 5A and 5B, the base plate 150 is produced (step 1002). Step 1002 forms the boss 154 in the plate section 151 of the base plate 150 by press work and, if necessary, cutting and drilling works. The boss 154 has an extended section or rim 156 and an opening 157, as shown in FIG. 7 at its top. The extended section 156 and its vicinity form part that plastically deforms through swaging or caulking. Here, FIG. 7 is a schematic enlarged plane and sectional views of the base plate 150.

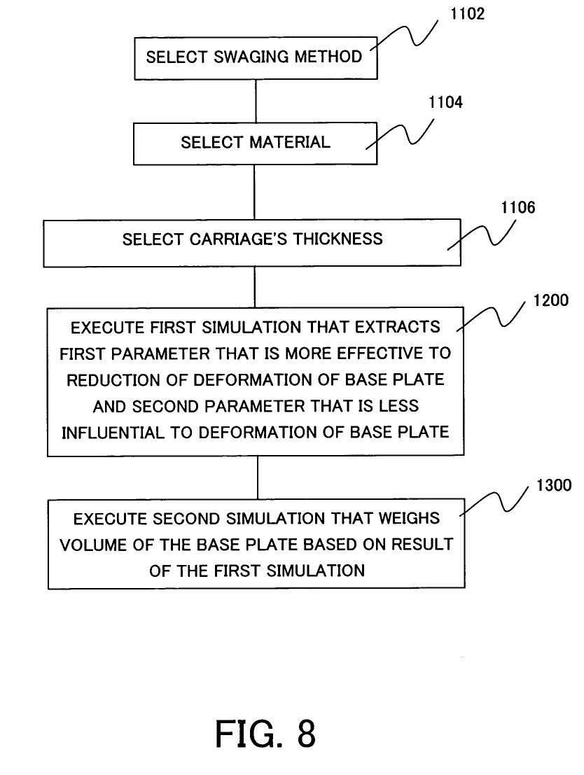

This embodiment optimizes the shape of the boss 154 formed in step 1002 through simulation so as to minimize the deformations of the base plate 150 and the arm 144 during swaging or caulking in step 1008, which will be described later. Referring now to FIGS. 8 to 12, a description will be given of an optimization method of the boss's shape. Here, FIG. 8 is a flowchart for explaining the optimization method of the boss's shape.

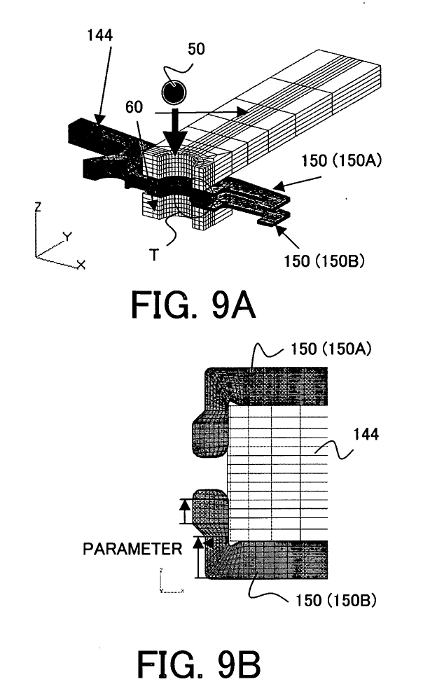

The first step selects a swaging or caulking method (step 1102). The swaging method includes use of a swaging ball, use of ultrasonic swaging, etc. A rod is attached to the swaging ball to squeeze the swaging ball into the opening 157 in using the swaging ball. The ultrasonic swaging also uses a rod-cum swaging ball, but vibrates the rod longitudinally via ultrasonic waves. The vibrations hit the swaging ball into the opening 157. Since a deformation amount of the base plate 150 may differ between use of the swaging ball and use of ultrasonic swaging, and the step 1102 allows a user to select the swaging method. FIG. 9A is a schematic perspective view of swaging of the double-head arm using the swaging ball 50. FIG. 9B is a partially enlarged sectional view of a T part in FIG. 9A. In FIG. 9A, 60 denotes a pair of wedges to hold the arm 144 and the base plate 150 during swaging.

The next step selects a material for each component (step 1104). While this embodiment selects aluminum for the carriage 140 and SUS for the base plate 150, the present invention does not limit a selection of the material to this embodiment. When the material differs, the optimal value of the boss's shape greatly differs.

The next step selects the thickness of the carriage 140 (step 1106). The carriage or AC block 140 may have different thicknesses according to locations. Since the thickness of the carriage 140 influences the deformation amount of the base plate 150, step 1104 allows a user to select the thickness.

Next follows a first simulation that extracts a first parameter that is effective to a reduction of a deformation of the base plate 150, and a second parameter that does not contribute to a reduction of a deformation of the base plate 150 (sep 1200). The step 1200 does not weigh the volume of the base plate 150, and thus can promptly extract the first and second parameters. Next follows a second simulation that weighs the volume of the base plate 150 based on a result of the first simulation.

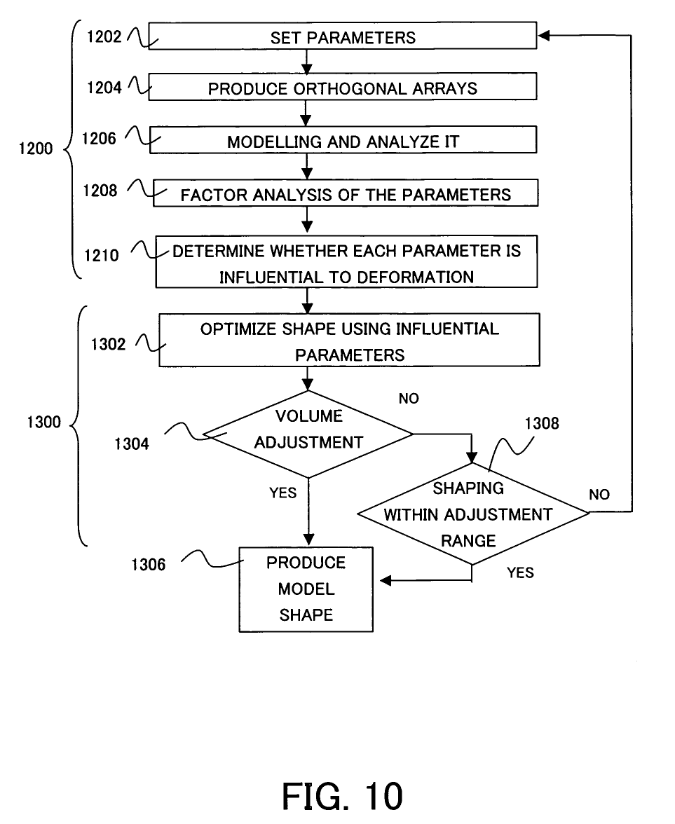

Referring now to FIGS. 10 to 12, a more detailed description will be given of steps 1200 and 1300. Here, FIG. 10 is a detailed flowchart of the steps 1200 and 1300.

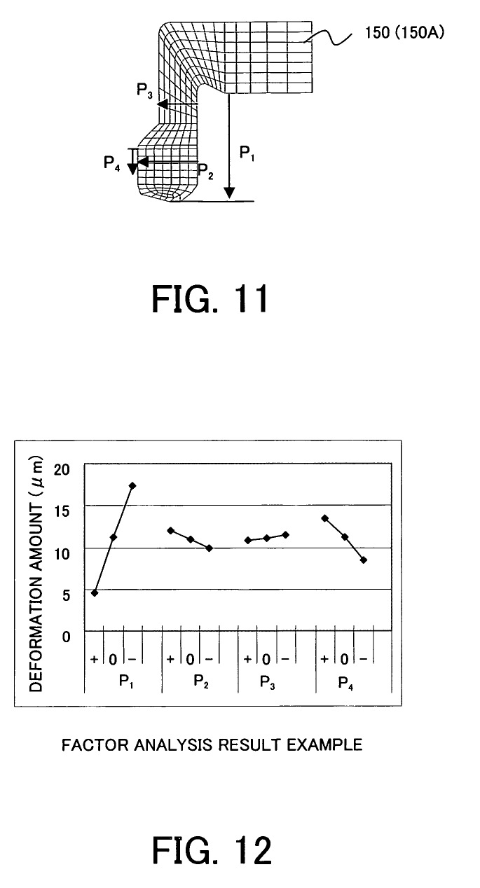

The step 1200 initially sets parameters of the boss's shape and their initial values to optimize the shape of the base plate 150 (step 1202). FIG. 11 shows illustrative parameters to be selected for the shape of the base plate 150. Among the illustrated parameters, P₁ denotes a length of the boss part. P₂ denotes a width of the tip of the boss part. P₃ denotes a width of the boss part rear edge. P₄ denotes a length of the tip of the boss part. Here, FIG. 11 is a schematic sectional view of the upper base plate 150A before swaging. While FIG. 11 sets four parameters P₁ to P₄, the present invention does not limit the type and number of parameters to those shown in FIG. 11. The parameter may include information that is irrelevant to the shape of the base plate 150, such as a diameter of the swaging ball 50, and the frequency of the ultrasonic wave.

Next, the orthogonal array is produced (step 1204), and the model is produced and the analysis is executed (step 1206).

The orthogonal array is used for a design of experiments (“DOE”). The DOE that uses the orthogonal array is an approach that plans the most effective experiment, and determines the way of analyzing data obtained from the experiment and a prediction of a result, in an attempt to improve and optimize performances of a process, product, service and solution. Advantageously, the DOE can reduce the number of experiments in combination with the orthogonal array for fast processing.

Tables 1 to 3 denote an L4 (2ˆ3) orthogonal array, an L8 (2ˆ7) orthogonal array, and an L9 (3ˆ4) orthogonal array. “4” in L4 denotes the number of experiments or analyses. (2ˆ3) denotes two levels and three parameters. The “level” is a setting range, and means the shape varying amount of the boss in this embodiment. In Tables 1 to 3, “No.” denotes the number of analyses. The row number corresponds to each parameter.

Table 4 is a table that indicates numerical values of parameters A to D in the levels 1 to 3. Here, the parameters A to D in Table 4 correspond to the parameters P₁ to P₄ in FIG. 11. The numerical value in Table 4 denotes each parameter's varying amount: For example, for the level 1, the parameter A corresponding to P₁ is changed by −0.02. This numerical value may be a ratio of the parameter's change from a reference value or an actual size.

If it is assumed that the shape size is changed as in Table 4 in an assignment using the parameters P₁ to P₄ in FIG. 11, the assignment needs three levels and four parameters or the L9 orthogonal array. 3ˆ4=81 experiments are actually necessary to meet all the combinations of three levels and four parameters, but the DOE using the orthogonal array needs only 9 kinds as in the L9 orthogonal array. The parameters defined in Table 4 are assigned to Table 3 to determine the shape varying model. The row numbers 1 to 4 in Table 3 correspond to parameters A to D in Table 4. The numerical values in Table 3 mean the levels in Table 4. The assignment of the numerical values in Table 4 to Table 3 needs the numerical values shown in Table 3: For example, the numerical value “1” is put at an intersection between No. 1 in Table 3 and the row number 1. With reference to the level “1” in Table 4, a value “−0.02” of the parameter A corresponding to row number 1 is extracted, and Table 3 is assigned. This procedure is repeated, and each parameter is assigned to Table 3. Table 5 is created after the assignment. The model denotes column numbers 1 to 9 in Table 5 or is a model for a necessary experiment. Each experiment does not weigh the volume of the base plate 150. One result is obtained for each model through the analysis in the step 1206.

TABLE 1
L4 (2\hat{ }3)

| | ROW NUMBER | | |
|---|---|---|---|
| No. | 1 | 2 | 3 |
| 1 | 1 | 1 | 1 |
| 2 | 1 | 2 | 2 |
| 3 | 2 | 1 | 2 |
| 4 | 2 | 2 | 1 |

TABLE 2
L8 (2\hat{ }7)

| | ROW NUMBER | | | | | | |
|---|---|---|---|---|---|---|---|
| No. | 1 | 2 | 3 | 4 | 5 | 6 | 7 |
| 1 | 1 | 1 | 1 | 1 | 1 | 1 | 1 |
| 2 | 1 | 1 | 1 | 2 | 2 | 2 | 2 |
| 3 | 1 | 2 | 2 | 1 | 1 | 2 | 2 |
| 4 | 1 | 2 | 2 | 2 | 2 | 1 | 1 |
| 5 | 2 | 1 | 2 | 1 | 2 | 1 | 2 |
| 6 | 2 | 1 | 2 | 2 | 1 | 2 | 1 |
| 7 | 2 | 2 | 1 | 1 | 2 | 2 | 1 |
| 8 | 2 | 2 | 1 | 2 | 1 | 1 | 2 |

TABLE 3
L9 (3\hat{ }4)

ROW NUMBER

| No. | 1 | 2 | 3 | 4 |
|---|---|---|---|---|
| 1 | 1 | 1 | 1 | 1 |
| 2 | 1 | 2 | 2 | 2 |
| 3 | 1 | 3 | 3 | 3 |
| 4 | 2 | 1 | 2 | 3 |
| 5 | 2 | 2 | 13 | 1 |
| 6 | 2 | 3 | 1 | 2 |
| 7 | 3 | 1 | 3 | 2 |
| 8 | 3 | 2 | 1 | 3 |
| 9 | 3 | 3 | 2 | 1 |

TABLE 4
PARAMETER AND LEVEL RANGE

PARAMETER

| LEVEL | A | B | C | D |
|---|---|---|---|---|
| 1 | −0.02 | −0.02 | −0.01 | −0.02 |
| 2 | 0 | 0 | 0 | 0 |
| 3 | +0.02 | +0.02 | +0.01 | +0.02 |

TABLE 5
ASSIGNMENT TO L9 ORTHOGONAL ARRAY

PARAMETER

| No. | 1 | 2 | 3 | 4 |
|---|---|---|---|---|
| 1 | −0.02 | −0.02 | −0.01 | −0.02 |
| 2 | −0.02 | 0 | 0 | 0 |
| 3 | −0.02 | +0.02 | +0.01 | +0.02 |
| 4 | 0 | −0.02 | 0 | +0.02 |
| 5 | 0 | 0 | +0.01 | −0.02 |
| 6 | 0 | +0.02 | −0.01 | 0 |
| 7 | +0.02 | −0.02 | +0.01 | 0 |
| 8 | +0.02 | 0 | −0.01 | +0.02 |
| 9 | +0.02 | +0.02 | 0 | −0.02 |

The next step executes a factor analysis of each parameter (step 1208). The “factor analysis” means a process that obtains a relationship between each parameter and the deformation amount of the base plate 150. As a result of the analysis in the step 1206, nine results are obtained for nine models, and a relationship between the each parameter and the deformation amount of the base plate 150 for each level is obtained from each result. FIG. 12 shows the factor analysis obtained from the assignment result to the L9 orthogonal array in Table 5. The abscissa axis denotes the level of each of the parameters P₁ to P₄. The illustrated code corresponds to a code of each parameter. The ordinate axis denotes the deformation amount of the base plate 150.

The next step extracts a parameter that is more influential to the deformation of the base plate 150, and a parameter that is less influential to the deformation of the base plate 150 (step 1210). The step 1210 uses a predetermined threshold for the factor analysis result to classify the parameters. From the result shown in FIG. 12, each parameter is relevant to the deformation of the base plate 150 to some extent. However, use of the predetermined threshold enables a parameter that is more influential to the deformation of the base plate 150, and a parameter that is less influential to the deformation of the base plate 150, to be extracted. Even when the values of the parameters P₂ and P₃ in FIG. 12 or boss's sizes change between plus and minus, the deformation amount fluctuates in such a small range that the parameters P₂ and P₃ can be regarded as a parameter that is less influential to the deformation of the base plate 150. On the other hand, when the values of the parameters P₁ and P₄ or boss's sizes change between plus and minus, the deformation amount fluctuates in such a wide range that the parameters P₁ and P₄ can be regarded as a parameter that is more influential to the deformation of the base plate 150.

A gradient direction in FIG. 12 corresponds a change of each parameter's value to a change of the deformation amount. For example, as a value of the parameter P₁ or boss's size increases, the deformation amount of the base plate 150 is likely to decrease. Similarly, as a value of the parameter P₄ or boss's size increases, the deformation amount of the base plate 150 is likely to increase.

Next, the parameters that are more influential to the deformation of the base plate 150, and the parameter that are less influential to the deformation of the base plate 150 are classified and ranked. The parameters that are more influential to the deformation of the base plate 150 are ranked in the most influential order. The parameters that are more influential to the deformation of the base plate 150 are ranked in the least influential order. Then, Table 6 is obtained:

TABLE 6

| More Influential Parameters | Less Influential Parameters |
|---|---|
| First Place: P₁ | First Place: P₃ |
| Second Place: P₂ | Second Place: P₄ |
| (ranking in order of greater | (ranking in order of smaller |
| fluctuation or gradient) | fluctuation or gradient) |

Next, step 1300 produces an optimal shape using the more influential parameters (step 1302). In optimizing the shape of the base plate 150, the parameters that are more influential to the deformation of the plate 150 are changed so as to reduce the deformation of the base plate 150.

The step 1302 processes with the following priority order in this embodiment:

A first method determines whether an ideal optimization is obtained for each parameter in reducing the deformation of the base plate 150. The optimization utilizes FIG. 12 without using Table 6. It is understood from FIG. 12 that the parameters P₁ to P₄ each has a direction of reducing the deformation as the parameter value increases or decreases, wherein the parameters P₁ to P₃ are preferably changed in the + direction and the parameters P₂ and P₄ are preferably changed in the − direction. Accordingly, it is determined whether the volume of the base plate 150 is sufficient when these parameters are changed in these directions.

A second method determines Table 6, which classifies the parameters into those which are more influential to the deformation of the base plate 150 and those which are less influential to the deformation of the base plate 150. The shape of the base plate 150 is optimized only by using the more influential parameters, and the less influential parameters are used to adjust the volume. Initially, it is determined whether the shape of the base plate 150 is optimized only by using the more influential parameters. For example, it is the + direction for the parameter P₁ to reduce the deformation of the base plate 150, whereas it is the − direction (which reduces the size or volume of the boss) for the parameter P₄ to reduce the deformation of the base plate 150.

Thus, the direction of the parameter P₁ and P₄ used to reduce the deformation amount of the base plate 150 are the direction to increase the size or volume of the boss for the parameter P₁ and the direction to decrease the size or volume of the boss for the parameter P₄. The optimization and the volume adjustment can be simultaneously conducted by first extracting the parameters that are influential to the deformation amount of the base plate, and then by combining one or more sub-parameters among those parameters having opposite directions of increasing/decreasing the volume of the boss. Characteristically, this method maximizes the optimization effect since it uses only the parameters that are influential to the reduction of the deformation of the base plate 150.

After the values of the parameters that are influential to the deformation amount of the base plate are changed, whether the volume of the boss increases or decreases is determined. When the volume increases or decreases, the boss's volume is adjusted by changing a numerical value of the parameter that is less influential to the deformation of the base plate.

The third method uses Table 6. The third method optimizes the boss's shape by using the more influential parameters in order of greater fluctuation, thereby maximizing the effect of reducing the deformation amount. The less influential parameters are used in order of smaller fluctuation to the base plate 150 for the volume adjustment, thereby minimizing the influence of the deformation due to the volume adjustment. Accordingly, it is first determined whether the boss shape can be optimized only by the parameter P₁ that is the most influential to the reduction of the deformation of the base plate 150, and then it is determined whether only the parameter P₃ can adjust the associated volume fluctuation of the boss. Unless only the parameter P₁ can optimize the boss's shape, whether a combination of P₁ and P₄ or only P₄ can optimize the boss's shape is determined. Unless only the parameter P₃ can adjust the boss's volume, whether a combination of P₃ and P₂ or only P₂ can optimize the boss's shape is determined.

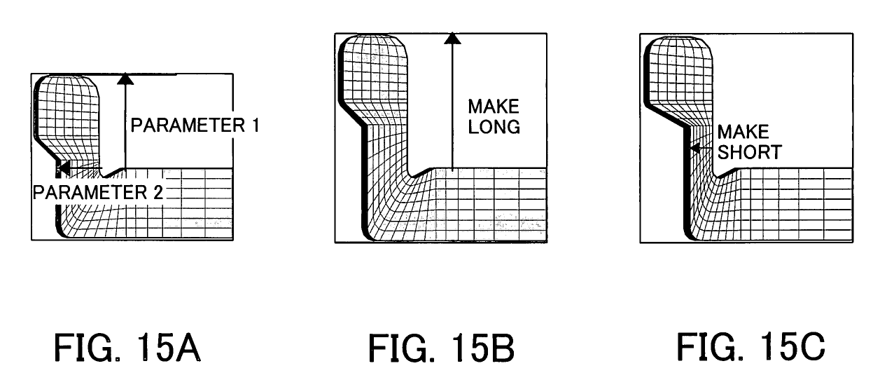

FIGS. 15A to 15C are sectional views for explaining the volume adjustment of the boss part. FIG. 15A contemplates the parameters 1 (the length of the boss part) and 2 (the width or the root of the boss part). The parameter 1 influences the deformation of the base plate 150, and reduces the deformation of the base plate as the parameter 1 increases. The parameter 2 is less influential to the deformation of the base plate 150, even when the value of the parameter 2 is changed.

In this case, an optimal value that most effectively reduces the deformation of the base plate is calculated (FIG. 15B) by increasing the parameter 1. Since values of the other parameters are maintained, the volume of the boss part is greater than the original volume of the boss part, and becomes insufficient.

Accordingly, the parameter 2 that is less influential to the deformation of the base plate is adjusted (FIG. 15C). In this case, since a value of the parameter 2 is adjusted so that the volume of the boss reduces, the value of the parameter 2 becomes smaller or the root of the boss part becomes narrower. Thus, the volume of the boss part is adjusted by changing the value of the parameter 2. This adjustment is repeated until the volume of the boss part in FIG. 15C is at least equal to the volume of the boss part in FIG. 15A. There may be plural parameters to be changed in adjusting the volume.

When the volume or mass of the boss runs short according to the first to third methods, the classification in Table 6 is corrected (fourth method) (step 1308). In this case, the more influential parameters are shifted in order of smaller fluctuation to the parameters for the volume adjustment. For example, only the parameter P₁ is used for the optimization of the boss shape, and the parameters P₂ to P₄ are used to adjust the volume. As in this embodiment, the parameter that is used for the volume adjustment is preferably the least influential to the base plate among the more influential parameters, so as to enhance the deformation reducing effect and minimize the influence of the deformation due to the volume adjustment. When the fourth method can achieve both the optimization and the volume adjustment, the optimal shape of the base plate 150 is determined as a model (step 1306), and the base plate 150 is produced in accordance with the model (step 1002).

Unless the fourth method can achieve both the optimization and the volume adjustment (step 1308), setting of the parameters (step 1202) is changed. For example, the number of parameter is increased, the locations of the parameters are changed, etc.

This embodiment forms the upper and lower base plates 150A and 150B having the same shape. Since only one type of base plate 150 may be produced, the manufacture becomes easier than manufacturing of two different types for the upper and lower base plates. However, the swaging ball 50 moves in one direction or from the top to the bottom in FIG. 9A, and a moving direction of the swaging ball 50 when viewed from each base plate is not the same and the deformation of each base plate is not symmetrical. In order to reduce the deformation of the upper and lower base plates 150A and 150B more accurately, separate parameters may be set for the upper and lower base plates 150A and 150B. For example, four parameters shown in FIG. 11 are set in the lower base plate 150B so as to use totally eight parameters. In this case, a (3ˆ8) orthogonal array is needed, but the procedure is the same as that shown in FIG. 10.

After the step 1002, turning back to FIG. 6, as shown in FIGS. 4A and 4B, the welded section 152 of the base plate 150 is laser-welded with the suspension 130 (step 1004). The magnetic head part 120 is attached to the suspension 130 before or after step 1004.

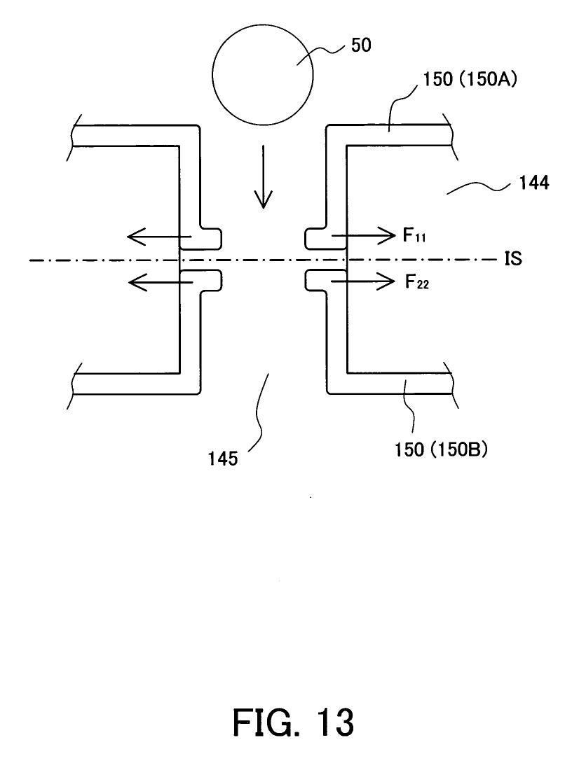

Next, as shown in FIG. 13, the base plate 150 is arranged at both sides of the arm 144 so that the boss 152 of each base plate 150 is inserted into the perforation hole 145 of the arm 144 (step 1006). Here, FIG. 13 shows that a pair of base plates 150 are arranged at both sides of the arm 144.

Next, swaging follows (step 1008). The swaging passes the swaging ball 50 whose diameter is slightly greater than a diameter of the opening 157, along one direction shown by an arrow through the perforation hole 145, as shown in FIGS. 9A and 13. As a result, the boss 154 of the base plate 150 crushes and plastically deforms as shown by horizontal arrows in FIG. 8, thereby jointing the base plates 150 with the arm 144. As shown by an alternate long and short dash line in FIG. 13, a surface that halves the thickness of the arm 144, and is perpendicular to the center axis of the perforation hole 145 is referred to as a neutral plane IS.

In the above embodiment with respect to the first to third methods, the “volume is sufficient” means that the volume of the boss part is maintained or decreases before and after the optimization. In order to decrease the volume, the original volume of the base plate 150 is reduced by cutting and drilling works in addition to press work. However, it is conceivable that when the volume excessively decreases, the swaging or caulking force decreases and the base plate 150 is likely to drop from the arm 144. Accordingly, the swaging force may set the lower limit when the volume is reduced. The swaging forces are labeled F₁₁ and F₂₂ in FIG. 13.

In addition, the locations of F₁₁ and F₂₂ and a difference between them cause a moment and a resultant deformation. Accordingly, when there are plural models, the step 1306 may select one of them, which provides the least moment caused by the locations of F₁₁ and F₂₂ and a difference between them.

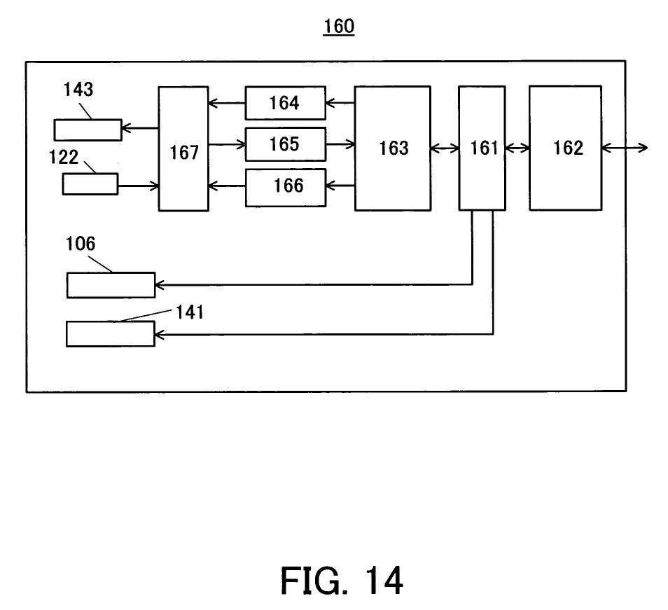

FIG. 14 shows a control block diagram of a control system 160 in the HDD 100. The control system 160 is a control illustration in which the head 122 has a inductive head and an MR head. The control system 160, which can be implemented as a control board in the HDD 100, includes a controller 161, an interface 162, a hard disc controller (referred to as “HDC” hereinafter) 163, a write modulator 164, a read demodulator 165, a sense-current controller 166, and a head IC 167. Of course, they are not necessarily integrated into one unit; for example, only the head IC 167 is connected to the carriage 140.

The controller 161 covers any processor such as a CPU and MPU irrespective of its name, and controls each part in the control system 160. The interface 162 connects the HDD 100 to an external apparatus, such as a personal computer (“PC” hereinafter) as a host. The HDC 163 sends to the controller 161 data that has been demodulated by the read demodulator 165, sends data to the write modulator 164, and sends to the sense-current controller 166 a current value as set by the controller 161. Although FIG. 14 shows that the controller 161 provides servo control over the spindle motor 106 and (a motor in) the carriage 140, the HDC 163 may serve as such servo control.

The write modulator 164 modulates data and supplies data to the head IC 162, which data has been supplied, for example, from the host through the interface 162 and is to be written down onto the disc 104 by the inductive head. The read demodulator 165 demodulates data into an original signal by sampling data read from the disc 104 by the MR head device. The write modulator 164 and read demodulator 165 may be recognized as one integrated signal processing part. The head IC 167 serves as a preamplifier. Each part may apply any structure known in the art, and a detailed description thereof will be omitted.

In operation of the HDD 100, the controller 161 drives the spindle motor 106 and rotates the disc 104. The airflow associated with the rotation of the disc 104 is introduced between the disc 104 and slider 121, forming a minute air film and thus generating the buoyancy that enables the slider 121 to float over the disc surface. The suspension 130 applies an elastic compression force to the slider 121 in a direction opposing to the buoyancy of the slider 121. The balance between the buoyancy and the elastic force spaces the magnetic head part 120 from the disc 104 by a constant distance. As discussed above, the warp amount of the base frame 150 is restrained, and the elastic compression force applied from the suspension 130 and orientation, flying height and vibration tolerance etc. of the slider 121 are close to the designed values. Therefore, highly precise positioning of the head 122 is available while the crushes are prevented.

The controller 161 then controls the carriage 140 and rotates the carriage 140 around the support shaft 142 for head 122's seek for a target track on the disc 104. While this embodiment thus uses a swing arm type in which the slider 121 draws an arc locus around the support shaft 142, the present invention is applicable to a linear type in which the slider 121 draws a linear locus.

In writing, the controller 161 receives data from the host (not shown) such as a PC through the interface 162, selects the inductive head device, and sends data to the write modulator 164 through the HDC 163. In response, the write modulator 164 modulates the data, and sends the modulated data to the head IC 167. The head IC 167 amplifies the modulated data, and then supplies the data as write current to the inductive head device. Thereby, the inductive head device writes down the data onto the target track.

In reading, the controller 161 selects the MR head device, and sends the predetermined sense current to the sense-current controller 166 through the HDC 163. In response, the sense-current controller 166 supplies the sense current to the MR head device through the head IC 167. Thereby, the MR head reads desired information from the desired track on the disc 104.

Data is amplified by the head IC 167 based on the electric resistance of the MR head device varying according to a signal magnetic field, and then supplied to the read demodulator 165 to be demodulated to an original signal. The demodulated signal is sent to the host (not shown) through the HDC 163, controller 161, and interface 162.

Thus, the present invention can provide an optimization method that effectively optimizing a component's shape.

Further, the present invention is not limited to these preferred embodiments, and various modifications and variations may be made without departing from the spirit and scope of the present invention. For example, while the above embodiments discuss the HDD, the present invention is applicable to other types of magnetic disc drives, such as a photo-magnetic disc drive, and does not limit a component to be optimized.

What is claimed is:

1. An optimization method for optimizing a shape of a component, said method comprising the steps of:
setting information including a shape of each part in the component to plural parameters;
extracting a relationship between the plural parameters and a deformation of the component;
changing a value of at least one of the plural parameters so as to reduce a deformation of the component; and
adjusting a volume of the component.

2. An optimization method according to claim 1, said extracting step uses a design of experiments that uses an orthogonal array.

3. An optimization method according to claim 1, wherein the information further includes information that is irrelevant to the shape of the component.

4. An optimization method for optimizing a shape of a component, said method comprising the steps of:
setting information including a shape of each part in the component to plural parameters;
extracting first and second parameters from among the plural parameters, the first parameter whose influence to a deformation of the component is greater than a predetermined threshold, and the second parameter whose influence to the deformation of the component is smaller than a predetermined threshold;
optimizing the component by changing a value of the first parameter so as to reduce a deformation of the component; and
adjusting a volume of the component by changing a value of the second parameter.

5. An optimization method according to claim 4, wherein said extracting step extracts the first parameter by changing the plural parameters within a predetermined range irrespective of the volume of the component.

6. An optimization method according to claim 4, wherein said extracting step extracts plural first parameters and ranks the plural first parameters in the most influential order to the deformation of the component,
wherein said optimizing step uses the plural first parameters in ascending order of ranking.

7. An optimization method according to claim 4, wherein said extracting step extracts plural second parameters and ranks the plural second parameters in the least influential order to the deformation of the component,
wherein said optimizing step uses the plural second parameters in ascending order of ranking.

8. An optimization method according to claim 4, wherein said extracting step extracts plural first parameters and ranks the plural first parameters in the most influential order to the deformation of the component,
wherein said optimizing step uses the plural first parameters in ascending order of ranking, and
wherein said adjusting step uses the plural first parameters in descending order of the ranking.

9. An optimization method according to claim 4, wherein the information further includes information that is irrelevant to the shape of the component.

10. An optimization method for optimizing a shape of a component, said method comprising the steps of:
setting information including a shape of each part in the component to plural parameters;
extracting plural first parameters from among the plural parameters, each first parameter having influence to a deformation of the component greater than a predetermined threshold;
extracting first and second sub-parameters from among the plural first parameters, the first sub-parameter increasing a volume of the component when the first sub-parameter is changed so as to reduce the deformation of the component, and the second sub-parameter decreasing the volume of the component when the second sub-parameter is changed so as to reduce the deformation of the component,
optimizing the component and adjusting the volume of the component by utilizing the first and second sub-parameters.

11. An optimization method according to claim 10, wherein the information further includes information that is irrelevant to the shape of the component.
